(19) United States
(12) Patent Application Publication
(10) Pub. No.: US 2014/0238014 A1
(43) Pub. Date: Aug. 28, 2014

(54) ENERGY DEVICE

(71) Applicant: Nanik Tirath Mulchandani, Mumbai (IN)

(72) Inventor: Nanik Tirath Mulchandani, Mumbai (IN)

(21) Appl. No.: 14/348,471

(22) PCT Filed: Sep. 10, 2012
(86) PCT No.: PCT/IN2012/000601

§ 371 Date: Mar. 28, 2014

(30) Foreign Application Priority Data
Sep. 30, 2011 (IN) 2793/MUM/2011

(51) Int. Cl. F03G 7/06

(52) U.S. Cl. CPC F03G 7/06
USPC 60/530; 60/516

(57) ABSTRACT

The present invention provides an apparatus for producing mechanical movement and then converting the same into electrical energy through expansion and compression of a medium.

### FIELD OF INVENTION

The present invention relates to an energy device. More particularly, the invention relates to an energy device and a method for generating electricity through expansion and contraction of a fluid.

### BACKGROUND

It is a well known fact that there has been substantial increase in fuel consumption in the last century. The rapid increase in demand for energy in the world has increased the demand manifold in the last few decades and there has been enormous pressure on energy suppliers to meet the demands of fuel consumers all over the world, which has led to dwindling resources related to fossil fuels. The increasing impact of depletion of fossil fuels has led to research in alternative source and especially clean fuel technology. Efforts within the field of renewable energy have been undertaken with considerable momentum, particularly over the last two decades, resulting in development of clean alternate energy sources with solar/sun, water and wind, being the major options for green power generation.

The present invention relates to an energy device wherein the device generates power which could be used for power generation and also in any vehicle such as a car, tractor or any other mechanical device driven by motive power. The present invention relates to specification of an energy device apparatus and its mode of operation can be either directly embodied on board a vehicle or otherwise for generating power.

### OBJECTS OF INVENTION

It is the primary object of the present invention to provide an energy device producing power using alternate clean technology.

It is another object of the present invention that it may operate without using fossil fuels.

It is another object of the present invention to provide an energy device with no fuel consumption.

It is another object of the present invention to provide energy device which is non hazardous and ecologically friendly.

It is another object of the present invention to provide energy device which meets ever increasing energy needs.

It is another object of the present invention that provides a simple design, thus reducing construction and maintenance costs.

### BRIEF DESCRIPTION OF DRAWINGS:

FIG. 1 is Hg Mover in accordance with an aspect of the present invention.

FIG. 2 is layout of Hg Mover to Volumetric amplifier in accordance with an aspect of the present invention.

### DETAILED DESCRIPTION OF THE INVENTION

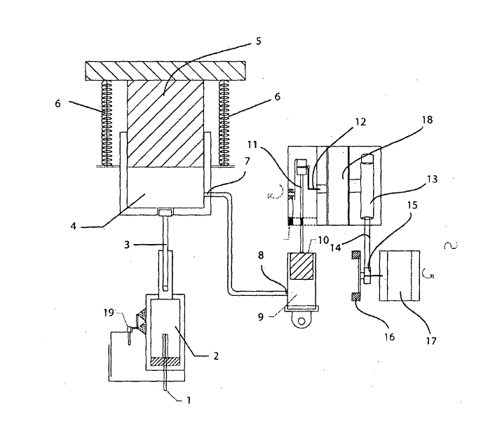

The present invention describes an energy device through the embodiments comprising a cylindrical chamber (2) embedded with a heat capsule (1), piston (3), crankshaft (11), gear box (18) and an electrical generator (17) connected externally, as per FIG. 2.

The present invention provides an apparatus for producing mechanical movement and then converting the same into electrical energy through expansion and compression of a medium like mercury (Hg). The apparatus includes a volumetric amplifier (4) which is attached to a cylindrical container filled with liquid mercury (2) (herein after referred as Hg Mover) with heater capsule (1). The volumetric amplifier is connected to a gear box (18) and externally to the electrical generator (17).

In the present invention, a heat capsule (1) which is connected with the Hg mover (2), receives heat energy from an external source and causes a, change in temperature of the Hg mover (2). The change in temperature is characterized by an increase of temperature in response to a heat supply from said heat capsule (1), and a decrease in temperature in response to a cooling effort/effect with a cooling arrangement like a water spray (19).

In response to the heat energy received by the heat capsule (1) and the Hg mover chamber (2), the Hg metal capable of transforming into a fluid at temperatures in excess of 25° C. (approximately), expands within said Hg mover chamber (2) to occupy more volume. The effective volume available within the Hg mover (2) being fixed, results in the movement of the piston (3) away/out from said Hg mover chamber (2). The movement of piston (3) away from the Hg mover chamber (2) marks the completion of a semi-stroke. In response to the completion of the semi stroke, the piston (3) being connected with a volumetric amplifier (4) causes the flow of hydraulic fluid from said volumetric amplifier (4) to the secondary hydraulic cylinder (9). The hydraulic fluid passes from the outlet/inlet port (7) of volumetric amplifier (4), into inlet/outlet port (8) of said secondary hydraulic cylinder (9), causing the piston (10) inside the secondary hydraulic cylinder (9) to expand. The contraction and/or expansion of the piston (10) in said secondary hydraulic cylinder is about 100 mm.

The volume for hydraulic fluid to move 2.3 cm diameter piston with 10 cm stroke is:

(2.3)²*0.785*10=41.5265 cm³=241.56 ml brake fluid

To convert 22 mm movement to achieve 41.56 ml or 42 ml hydraulic fluid displacement is:

d²*0.785*2.3 cm=42 ml or 42 cm³

d²=42/(1.8055)=23.26225422 cm²

d=\sqrt{23.26225442} cm

d=4.823095917 cm or d=48.23 mm diameter

or d=48.25 mm dia cylinder

The volume amplification is done from 0.6 cm3 =42 cm3 in hydraulic fluid.

The pressure required is approximately 6 Hp through movement of gear box.

The r.p.m. enhancement is 1 r.p.m. to 1500 r.p.m.

As calculation shows it is producing 0.9 mega watt energy for 1 r.p.m. to convert it to 1500 r.p.m. at 6 HP or 5 kVA.

The piston (3) gets retracted back into said Hg mover chamber (2), in response to the cooling action of said cooling arrangement (19), which results in contraction of Hg medium inside said Hg mover chamber (2). The completion of the forward stroke wherein said piston (3) moves away from said Hg mover chamber (2) in response to the Hg expansion, followed by a return stroke wherein said piston (3) moves towards said Hg mover chamber (2) in response to the Hg contraction, marks the completion of a full stroke. In response to the full stroke, the hydraulic fluid from said secondary hydraulic cylinder (9), flows back into said volumetric expansion chamber (4) through the corresponding outlet/inlet ports (7, 8) of said secondary hydraulic cylinder (9) and/or said volumetric amplifier (4). The process of repeated full strokes results in repetition of the piston (3) movements of the hydraulic cylinder (2) and/or the volumetric amplifier (4) and/or the secondary hydraulic cylinder (9).

As described in FIG. 2, the repeated movement of the piston (10) in said secondary hydraulic cylinder (9) causes the rotation of the crank (11) connected with said crankshaft (12). The rotary movement of crankshaft (12) is connected with a gearbox (18) for causing a step-up/step-down of the shaft (12) speed depending on the requirements of the electrical generator (17).

The output of the gearbox (18) is transferred to the flywheel (16) connected with the electrical generator (17), with the help of a gear arrangement (14) which meshes with the output gear (13) of the gearbox (18) and an external gear (15) on the flywheel (16) shaft. The rotation of the external gear (15), results in rotation of the flywheel (16) shaft and thereby the flywheel (16).

The flywheel (16) shaft being connected with said electrical generator (17), results in rotation of the rotor of said electric generator (17) and hence electrical energy is generated.

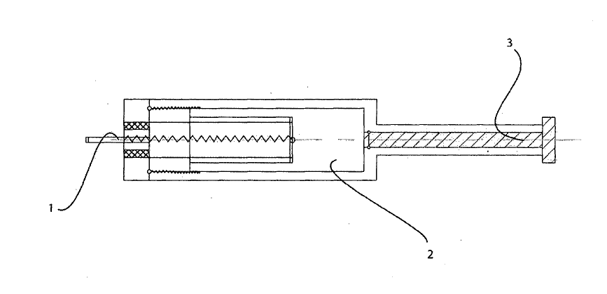

This Hg Mover (2) is made of stainless steel (SS 316), with a 5 mm diameter by 100 mm long piston cylinder holding piston (3) at one end and screwed end cover also holding a cylindrical capsule barged to the screwed end. Mercury is placed in a cylindrical container (2) and at an ambient temperature of 30 degrees Celsius, as per FIG. 1.

The Hg Mover, (2) is used to heat up mercury to a temperature of 100 degrees Celsius, which is constantly maintained by way of an embedded spray pump (19) and heater (1) having 62.5 watts at 12V DC supply. Volume of mercury is thus enhanced due to absorption of heat energy supplied through the heater (1). In addition, the embedded heater (1) is programmed to maintain the heat levels of the mercury, which is injected to the Hg Mover (2). This heat generates the movement of the liquid metal in the cylindrical chamber of Hg Mover (2) and expands out of said Hg mover chamber (2) by about 20 mm. The heating (1) and cooling (19) mechanism of mercury is done accordingly in the Hg Mover (2). The Hg Mover (2) maintains the liquid mercury at pressure levels (inputs). The mercury in the cylinder chamber (2) is prevented from leaking from the cylinder (2) through a seal with rubber O rings.

I claim:

1. An energy device powered by compression and expansion of a medium, comprising:
a. a cylindrical chamber which is preferably hollow with provisions for accommodating a piston, said compression and/or expansion medium and a heat capsule;
b. a heat capsule which can receive heat from an external source;
c. a piston which is connected with provisions in said cylindrical chamber;
d. a volumetric amplifier for amplifying energy;
e. at least a crankshaft, with a crank for converting reciprocating motion into rotary motion;
f. a flywheel which receives and/or stores and/or regulates said rotary motion; and
g. a generator coupled with said fly wheel to convert said rotary motion into electrical energy.

2. The energy device as claimed in claim 1, wherein said cylindrical chamber is preferably made of a metal.

3. The energy device as claimed in claim 1, wherein internal diameter of said cylindrical chamber is 25 mm.

4. The energy device as claimed in claim 1, wherein length of said cylindrical chamber is 115 mm.

5. The energy device as claimed in claim 1, wherein diameter of said piston is 5 mm.

6. The energy device as claimed in claim 1, wherein said piston expands from said cylindrical chamber by at least 20 mm.

7. The energy device as claimed in claim 1, wherein said volumetric amplifier further comprises:
a. a hollow cylindrical chamber; and
b. an occupying member supported and/or constrained by at least two helical springs which are connected with a support base.

8. The energy device as claimed in claim 1, wherein said occupying member is preferably made of a metal and/or an alloy.

9. A method of generating energy by compression and expansion of a medium comprising:
a. supplying heat to a compressible and/or expandable medium;
b. inducing a reciprocating motion to a piston from expansion and/or compression of said medium;
c. amplifying said reciprocating motion with a volumetric amplifier;
d. inducing a rotary motion to a crank and/or crankshaft mechanism from said reciprocating motion from said volumetric amplifier;
e. stepping-up and/or stepping-down said rotary motion with a gear/s arrangement;
f. transferring said stepped-up or stepped-down rotary motion to a flywheel arrangement with a gear;
g. stabilizing and/or storing and/or regulating said rotary motion in said flywheel;
h. feeding said rotary motion from said flywheel to an electrical generator; and
i. converting said rotary motion from said flywheel into electrical energy in said electrical generator.

10. The method as claimed in claim 8, wherein, said medium includes Mercury (Hg).
